(19) United States
(12) Patent Application Publication
(10) Pub. No.: US 2026/0348657 A1
(43) Pub. Date: Nov. 5, 2026

(54) MODULAR RF-HEATING SYSTEM FOR FREEZE-DRYING

(71) Applicant: Purdue Research Foundation, West Lafayette, IN (US)

(72) Inventors: Dimitrios Peroulis, West Lafayette, IN (US); Alina Peroulis-Alexeenko, West Lafayette, IN (US); Andrew David Strongrich, West Lafayette, IN (US); Ahmad Naif Darwish, Lafayette, IN (US)

(21) Appl. No.: 19/487,266

(22) PCT Filed: May 28, 2024
(86) PCT No.: PCT/US2024/031273

§ 371 Date: Nov. 24, 2025

Related U.S. Application Data
(60) Provisional application No. 63/468,996, filed on May 25, 2023.

(51) Int. Cl. F26B 5/04; F26B 5/06; F26B 21/35; F26B 21/40; F26B 25/06

(52) U.S. Cl. CPC F26B 5/048; F26B 5/044; F26B 5/06; F26B 21/35; F26B 21/40; F26B 25/06

(57) ABSTRACT

A freeze drier system may include a product chamber and a reflective scattering surface disposed in the product chamber. An RF source may be connected to an antenna directed at the scattering surface. The RF source may emit electromagnetic waves via the antenna and the scattering surface may reflect the electromagnetic waves in various directions to provide uniform heating in the product chamber.

### CROSS REFERENCE TO RELATED APPLICATIONS

This application claims the benefit of U.S. Provisional Application No. 63/468,996 filed May 25, 2023, the entirety of which is incorporated by reference.

### GOVERNMENT FUNDING

This invention was made with government support under 70NANB 17H002 awarded by NIST. The government has certain rights in the invention.

### TECHNICAL FIELD

This disclosure relates to biopharmaceutical lyophilization and, in particular, to biopharmaceutical lyophilization using electromagnetic fields.

### BACKGROUND

Due to the rising demand for lyophilized injectable medicines over the last few decades, the freeze-drying or lyophilization technique has recently received much attention. Freeze-drying is widely used in the pharmaceutical industry because it permits the processing of thermolabile products in sterile conditions, even though it is one of the most time-consuming industrial processes with an energy efficiency of <10%. To that purpose, RF/microwave-based lyophilization is being pursued because it significantly accelerates such processes. Nonetheless, most existing microwave-assisted lyophilization systems operate in the common industrial, science, and medical (ISM) band (2.45 GHZ). Such a frequency of operation usually results in high batch inhomogeneity due to the hot spots generated inside the dryer. It also results in a longer drying time since ice absorption to RF energy is significantly lower than 18 GHz.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of a system for freeze drying.

FIG. 2 illustrates a flow diagram for a system.

FIG. 3 illustrates an exploded view of a scattering plate having a scattering surface.

FIG. 4 illustrates an example of metallic elements included in a scattering surface.

FIG. 5 illustrates an example of a graph showing the reflection characteristic of a scattering surface.

FIG. 6 illustrates a layout of the metallic elements.

FIG. 7 illustrates an electromagnetic field uniformity validation setup.

FIG. 8 illustrates received power by RX for two different scattering surface angles.

FIG. 9 illustrates the absolute difference between received power by RX for two different scattering surface angles.

FIG. 10 below summarizes obtained maximum-to-minimum power ratio measurements as a function of frequency.

FIG. 11 compares a standard deviation of two systems as a function of frequency.

### DETAILED DESCRIPTION

Biopharmaceutical lyophilization, or freeze-drying, has become an indispensable cornerstone since World War II due to the high demand for product stabilization. While such a demand has consistently been increasing over the past 30 years due to the rapid development of biopharmaceutical processes, the COVID-19 pandemic has put lyophilized products in the daily news over the past two years. Despite the effectiveness of lyophilization, it is a time-consuming process, taking anywhere from days to weeks to complete with very low energy efficiency (<10%).

This disclosure addresses these, and other, shortcomings by applying high-frequency (8 GHZ-18 GHZ) electromagnetic waves that volumetrically heat the products as they dry. The system significantly reduces the drying time relative to conventional lyophilization (>2x speed up relative to conventional freeze-drying) while simultaneously improving overall heating uniformity among the product vials. The system also enables higher material throughput in certain applications since RF heating overcomes conduction heat transfer limitations imposed on conventional freeze-drying.

RF heating increases the throughput of bulk material drying. In this application, a bulk form (e.g., discrete spheres or a monolithic casting) is dried in a similar manner to vials. In the conventional approaches, heat is transferred from the temperature-controlled shelves into the product. Thermal diffusion dictates that a temperature gradient will exist between the point of contact with the shelf and the sublimation interface (i.e., from the warmest area to the coldest). Freeze-dried materials have a maximum temperature known as the critical temperature that cannot be exceeded during the primary drying phase. The existence of a critical temperature places a constraint on the maximum allowable drying rate as the warmest region must be kept below this value. Therefore, for large volumes, heat transfer to the upper layers where sublimation is occurring is severely limited and leads to conditions of low optimality. RF heating is volumetric and overcomes these limitations, allowing the entire bulk volume to receive comparable quantities of energy. Applying RF heating in this way leads to a significant increase in allowable material volume that ultimately enables higher overall throughput.

The present disclosure provides several technical advancements over conventional approaches, such as those described in U.S. Pat. No. 11,454,443. By way of example, a technical advancement described herein is the removal of the RF box and the mechanical stirrers found in conventional approaches. Previous approaches utilize an RF chamber (RF box) containing mechanical stirrers and a radiator (antenna) to be placed inside the freeze-dryer. Such a metallic chamber inside the freeze-dryer does not allow product stoppering. Hence, the dried products would be exposed to humid air, increasing the products' residual moisture content. Moreover, using a fully metallic encapsulated RF chamber prevents the visual inspection of the products during freeze-drying. In addition, the utilized mechanical stirrers are large, limiting the number of vials placed inside the box during drying. Since the mechanical stirrers need to be moving for effective uniformity, motors are attached to the RF box. This constitutes another drawback of previous approaches since the motors are placed inside the freeze-dryer. Finally, integrating temperature sensor probes inside the product vials is inconvenient and time-consuming due to the existence of the RF box.

The system and methods described herein replaces the mechanical stirrers with a scattering surface mixer, which improves the electromagnetic field homogeneity while acquiring a significantly smaller size inside the freeze-dryer (compared with the mechanical stirrers). The scattering surface mixer may be affixed to a metallic door, or some other portion, of a freeze-dryer due to its compact size. A motor positioned outside of the freeze dryer with a shaft that extends through the freeze dryer. Furthermore, the absence of an RF Box allows for, among other advantages, the stoppering of the product-filled vials at the end of the cycle. Additional technical advancements are made evident in the disclosure provided herein.

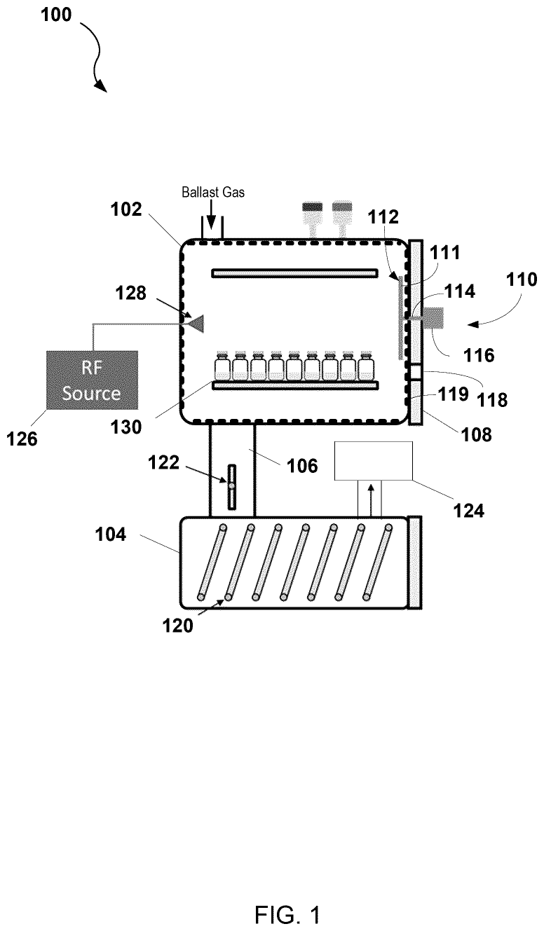

FIG. 1 illustrates an example of a system 100 for freeze drying. Freeze-drying is a manufacturing operation used to stabilize highly sensitive pharmaceutical drug and biological products prior to long-term storage.

The system 100 may include a product chamber 102 and a condenser chamber 104. A duct 106 may fluidly connect the product chamber 102 and condenser chamber 104.

A door 108 may be attached to the product chamber 102 to permit access inside the chamber. A scattering surface mixer 110 may be attached to the door 108. The scattering surface mixer 110 may include a scattering plate 111 having a scattering surface 112, a shaft 114, and a motor 116. The size of the scattering plate 111 facilitates its placement next to the door 108. The motor 116 used to rotate the surface 112 can be installed outside the product chamber 102. In some examples, the motor 114 may connect to a shaft 114 which drives the scattering surface 112. It should be appreciated that the scattering surface mixer could instead be located at various locations on or in the product chamber 102 in addition to or in alternative to the door 108. However, the door 108 provides an optimal location due to the ease of access, ease of retrofitting existing product chambers, and ease of maintenance among other considerations.

In other examples, the scattering surface 112 may be statically affixed to the door 108 and/or an inner wall of the product chamber. One advantage of such a system would be to remove the need for a motor and shaft, thus simplifying the system. When the scattering surface 112 is statically affixed, the electromagnetic emission directed at the surface 112 be frequency and/or power modulated to promote scattering. The scattering surface may be also present on other geometric structures other than a plat. For example, the scattering surface can be either flat or be a surface to any other geometrical structure (cylindrical, spherical, etc.)

The door 108 may also include a view port 118, or small window, to allow for visual (or infrared) inspection of the products during freeze-drying. In infrared imaging applications, the viewport may consist of electrically conductive material (e.g., germanium or silicon) that is optically transparent to wavelengths in the infrared bands. A shielding metallic mesh 119 is used to ensure that no RF leakage is allowed through the window. The mesh size is chosen to ensure visual inspection while keeping the RF energy stored inside the chamber. The mesh 119 may extend across the viewport opening. Alternatively or in addition, the mesh may extend around the inner surface of the product chamber. In some examples the mesh may extend across the opening of the duct 106 and/or prevent leakage from the product chamber 102 through any other openings or ports.

The product chamber 102 may receive ballast gas. Ballast gas is a non-condensable gas that is introduced into the freeze-drying equipment to regulate pressure around the user-defined setpoint. The product chamber may be connected to the condenser chamber 104 which includes a condenser 120. An isolation valve 122 may regulate fluid connection between the product chamber 102 and condenser chamber 104. For example, the isolation valve may be located in the duct 106, and the isolation valve may seal one chamber from the other. Product may be dried in the product chamber 102 and sublimed solvent vapor is trapped in the condenser chamber 104 and ballast gas is removed. A vacuum pump 124 may be connected to the condenser chamber 104 and draw a vacuum from the product chamber 102. Vacuum gauges are used to measure vacuum pressure and provide the feedback to the freeze-drying system necessary to regulate pressure around the user-defined setpoint. In traditional freeze-drying applications, the gas pressure is critical to both transferring heat from the shelves to the product as well as removing the solvent vapor from the sublimation interface. These mechanisms are competing and require optimization during cycle development. With RF heating, these constraints on pressure may be mitigated. Specifically, the pressure may be regulated at the lowest possible value such that the freeze-dryer equipment capability limits are not violated. The equipment capability limit is generally defined as the maximum permissible sublimation rate such that the system is able to maintain its commanded pressure setpoint.

The system 100 may include an RF Source 126. The RF source 126 is a component used to generate a high-frequency, high-power electromagnetic (RF) waves that are injected into the product chamber 102. In some examples, the RF source comprises two components, a signal generator used to generate the required high-frequency signal and a power amplifier to amplify the signal generated by the signal generator. Then, the amplified signal may be delivered to an antenna 128 through coaxial cables, for example, to radiate the RF waves inside the chamber 102. The radiated waves from the antenna 128 may be directed to hit the scattering surface 112 to scatter the wave across the chamber in multiple directions.

In examples where the scattering plate surface 112 is static, the RF source may modulate the electromagnetic emissions. By modulating the frequency while the scattering surface 112 is static, the scattered waves directions and intensity change. Hence, new electric field is achieved, providing a highly uniform field over time. This is conceptually similar to radiating the electromagnetic waves at a single frequency while rotating the surface.

In some examples, shelves 130 may be disposed in the chamber to receive product. The shelves may be temperature controlled. The shelves may assist freezing the product received by the shelves. Temperature-controlled shelves inside the freeze-drying chamber control the products' temperature by circulating a fluid through internal channels within the shelves. In the freezing stage, shelves are cooled to very low temperatures to freeze the products. In the proposed RF-assisted freeze-drying setup, the temperature can be either heated to facilitate sublimation process and moisture removal, or they can be kept at a low temperature to use only RF. In another experimental setup, non-metallic shelves could be used to use only RF.

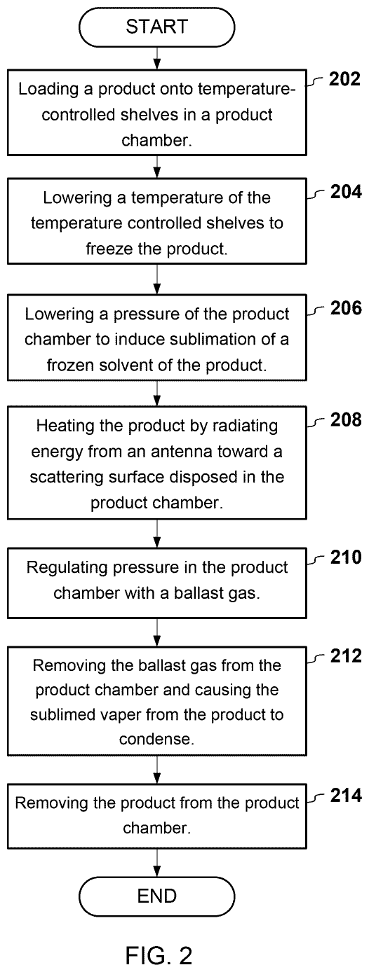

FIG. 2 illustrates a flow diagram for the system 100. The system 100 may perform freeze drying through various operations. Some of the following operations may change depending on the particular implementation. The product to be dried is loaded into the product chamber onto the temperature-controlled shelves (202). Here, product may refer to liquid-filled glass vials, bulk drug product or substance, medical devices, foams, tissue, food, etc. In some cases, the product is frozen prior to loading and the shelves are cooled to a user-defined temperature prior to loading.

The product chamber is sealed, and the temperature of the shelves is lowered until the product freezes (204). This step separates the solvent from the solute and provides a stable solid matrix in preparation for primary drying.

After the product has frozen and equilibrated at the target temperature, the pressure inside of the chamber is lowered using a vacuum pump (206). The pressure at this stage must be low enough to induce sublimation of the frozen solvent.

Thereafter, the product may be heated by radiating energy from an antenna toward a scattering surface disposed in the product chamber (208). The RF source is activated, and the antenna radiates energy in the form of high frequency waves into the product chamber. This heat addition is needed to offset the latent heat lost through sublimation. Additional heat may also be supplied by the shelves.

The pressure in the product chamber may be regulated with a ballast gas (210). An inert and non-condensable ballast gas (e.g., nitrogen) is also introduced into the product chamber to regulate pressure around a user-defined setpoint. A series of vacuum gauges provide the necessary feedback to the control system to perform this operation.

The gas ballast bypasses the condenser and is removed by the vacuum pump (212). The sublimed solvent vapor flows out of the vials, through the duct, and into the condenser chamber. The condenser is maintained at a very low temperature such that the solvent vapor condenses onto its surface. Primary drying is the longest phase of the freeze-drying process, taking from days to weeks to successfully complete.

After all bulk frozen solvent has been removed from the product, the temperature of the product is raised and maintained at a user-defined value to desorb the remaining bound water (214). This operation is known as secondary drying and may be accomplished by either the shelves or the RF source.

Following secondary drying, the RF system is deactivated, product is sealed inside of the sterile environment, and the pressure inside the freeze dryer is restored to atmosphere. The product is removed from the product chamber, capped, inspected, and labeled.

In previous approaches, an RF box was placed inside of the chamber and the RF box retained the vials. The system and methods described herein allow for the absence of the RF box, which thereby permits in-situ vial stoppering. In addition, the system provides the ability to easily place the temperature probes inside the vials for monitoring product temperature. Also, the metallic stirrers used previously are replaced with a scattering surface that can effectively stir the electromagnetic waves over a wide frequency range.

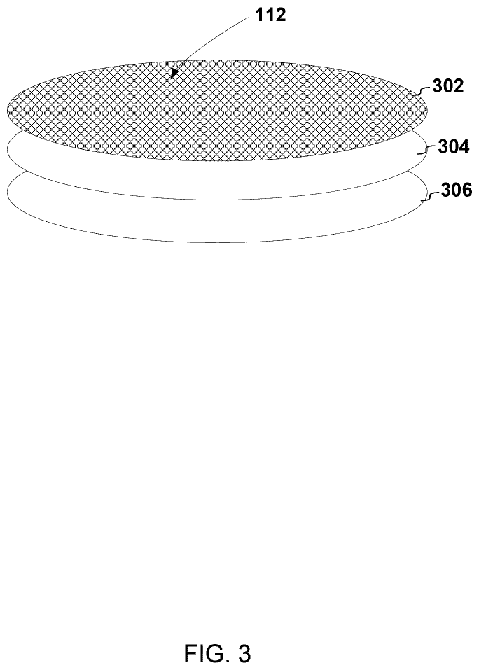

FIG. 3 illustrates an exploded view of a scattering plate. The scattering plate includes a scattering surface. The scattering surface effectively reflects and spreads the electromagnetic waves radiated by an antenna in various directions.

In the example shown in FIG. 3, the plate includes three layers. A first metal layer 302, a dielectric layer 304, and a second metal layer 306. The metal layers may include copper or some other suitable metal. The first metal layer 302 and/or the second metal layer 306 may be etched to form scattering surface having a pattern which reflects and scatters the electromagnetic waves.

When the RF waves hit the scattering surface, part of the signal will be reflected back to the chamber, and the rest will penetrate the dielectric layer of the substrate. These penetrated waves will undergo multiple reflections between the two metallic layers. These reflected waves will mutually interfere, resulting in a final reflected signal from the scattering surface back to the chamber. Depending on the top metal's used layout, waves will be reflected in a particular way over a particular frequency range. The goal is to ensure that the waves are scattered in all directions away from the surface to eventually have a well-stirred field inside the chamber.

Layout Design: A low permittivity substrate may be used to ensure that the waves are effectively scattered. In various experimentation described herein, RT/Duroid 5880 from Rogers was used since it has a low dielectric constant (permittivity of 2.2), very low loss, and is compatible with high-frequency applications. Other substrates are possible. Once the substrate was chosen, the layout of the top metallic surface was simulated to ensure that the size of the elements and their arrangement would result in a scattered field in all directions away from the surface (the size of every element was initially chosen to be λ/2 of the center frequency). Some fine-tuning for the elements to improve the performance was then carried out.

Mask Design: To use the Vacuum Contact Lithography method, a flexible film mask produced by Artnet Pro Inc. Dark field type was used to match the negative dry film photoresist in a further step.

Substrate Cleaning: Initially, the substrate is fully immersed in acetone, and constant manual agitation is carried out for 5 minutes. Then, the sample was immersed in a secondary bath with isopropanol to continue agitation for 5 minutes. Finally, the substrate was dried using a nitrogen gun and transferred on a clean aluminum foil for transportation to a different station.

Photolithography: Negative photoresist Tentmaster TM200i by DuPont was used and laminated on the substrate. Then, a vacuum sealing chamber is used to ensure that good contact between the mask and the photoresist is achieved (to accurately transfer the pattern from the mask to the photoresist). The mask is placed on top of the photoresist-covered substrate. The assembly is inserted inside a transparent vacuum pouch and placed in the chamber. After that, the assembly was transferred to the UV chamber. After exposure to UV light, the photoresist takes a distinguished dark blue color. After that, 5% w/v sodium bicarbonate DI water solution was used to develop the exposed photoresist. To speed up the dilution process, 5 minutes of ultrasonic agitation was incorporated into the process. The protective film was removed from the surface of the substrate and fully immersed into the developer. Constant agitation of the substrate in the developer is critical to gain uniformity across the large surface of the board. Then, the developed substrate was fully immersed into the CE-100 Copper Etchant solution by Transene Corp. The solution is expected to remove copper at room temperature. Finally, the etched substrate was fully immersed in an acetone bath and left to sit for 5 minutes. The photoresist delaminated from the substrate and floated within the solution. Isopropanol was used to rinse the substrate and then dried using a nitrogen gun.

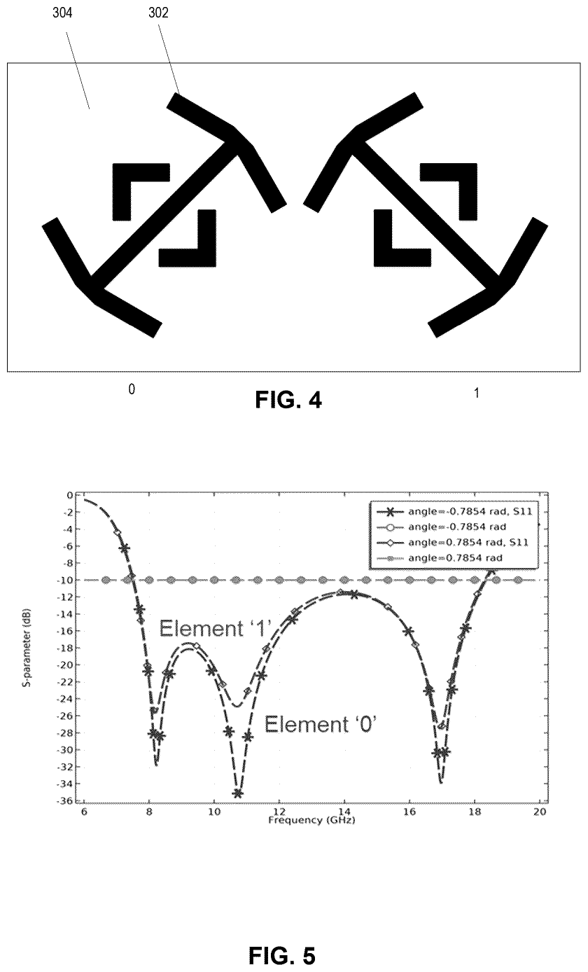

FIG. 4 illustrates an example of metallic elements included a top layer of a scattering plate. The metallic layout may include a plurality of elements (Element 0 (left) and Element 1 (right) in FIG. 4). The elements are the remaining metal on the plate after etching. Using elements with different orientations leads to different phase responses. In this experimentation, the elements provide scattering in a frequency range of 8 Ghz to 18 Ghz, though other ranges are possible.

The scattering surface used in this work is designed to receive RF waves radiated by an antenna and reflect these waves in different directions back to the chamber. Using the “0” and “1” elements allows for reflections in all directions rather than having the reflected signal focused in a single direction. To illustrate, if we only use a “0” or “1” arrangement, we will get the reflected signal focused in a single beam away from the scattering surface. Hence, no well-stirred field is obtained inside the chamber. For that reason, the surface includes an arrangement of the “0” and “1” elements to allow for scattering the waves in all directions away from the surface (multiple beams).

When a plane wave hits an anisotropic homogenous material, transmitted and reflected signals are generated. The transmitted signal undergoes multiple reflections between the two conductors to create a final reflected signal. We have chosen the structure used in Sun et al., “Metasurfaced Reverberation Chamber,” Sci Rep 8, 1577 (2018), to implement our scattering surface since it has a wideband and broad-angle characteristic. First, we have optimized a unit cell to ensure proper operation over the frequency of interest (8 GHZ-18 GHZ). The reflection characteristic of both elements (element “0” and element “1”) is depicted in FIG. 5.

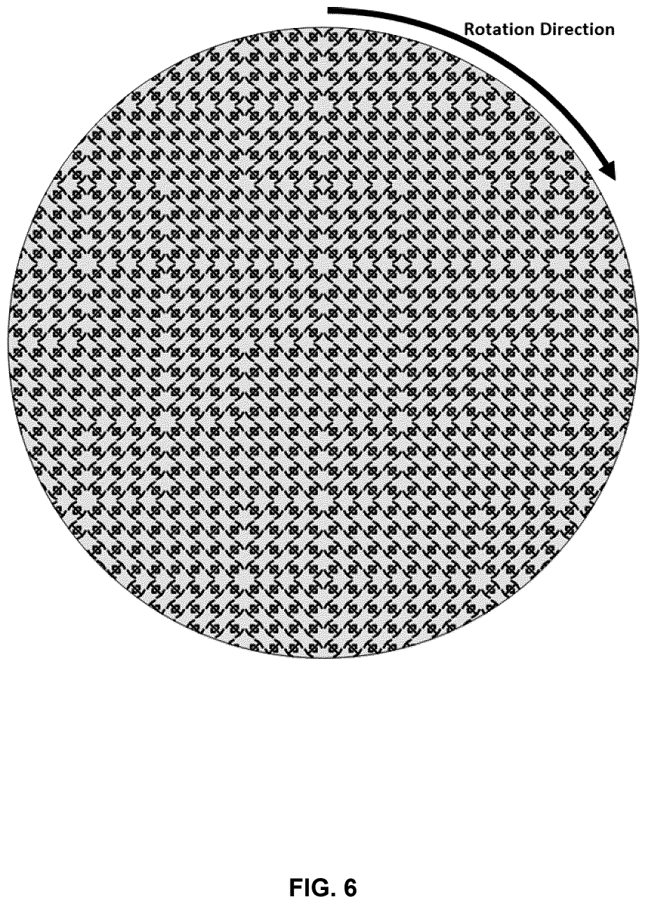

FIG. 6 illustrates a layout of the metallic elements. After designing the scattering surface elements, the different elements are arranged as shown in FIG. 6 to achieve an all-direction backscattering behavior. A detailed description of how the arrangement is chosen can be found in Sun et al., “Metasurfaced Reverberation Chamber,” Sci Rep 8, 1577 (2018). The scattering surface is also rotated inside the freeze-dryer using a stepper motor bolted to the door 108 to ensure that the scattered (reflected) signal directions are altered. Consequently, a uniform electromagnetic field distribution is obtained when a full rotation (360°) is completed.

Various experimentation were conducted to validate the system and methods described herein. The experimental results are not intended to limit the possible embodiments of the system and method described herein. The experimentation and related discussion may provide additional or alternative embodiments.

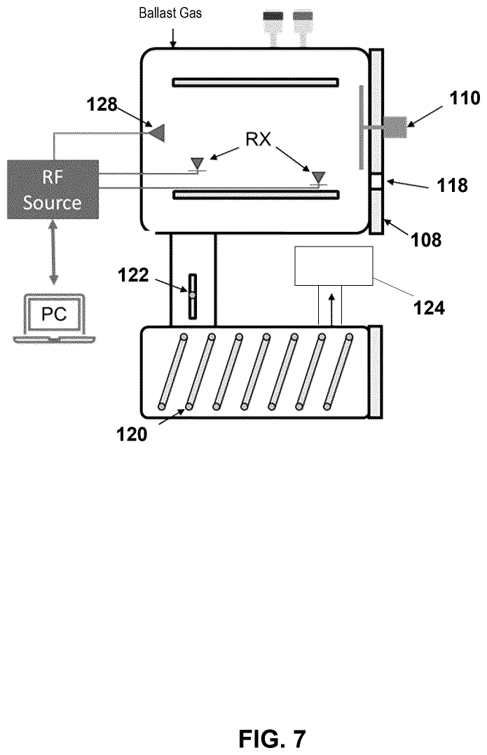

FIG. 7 illustrates an electromagnetic field uniformity validation setup. A scattering surface was placed inside a freeze-dryer. The antenna, on the other hand, is placed on the other side of the machine. To ensure that the system performance is acceptable, we obtained the statistical electromagnetic field metrics described in U.S. Pat. No. 11,454,443 and in Huang, “Fundamentals of the Reverberation Chamber, Anechoic and Reverberation Chambers,” John Wiley & Sons, Ltd, (2018). We used a vector network analyzer to transmit wideband electromagnetic waves using the transmitting antenna (TX) inside the freeze-dryer. We also placed a receiving antenna (RX) inside the dryer at arbitrarily chosen locations (in this measurement, we used twelve different locations, eight of which comprise the vertices of the volume occupied by the products). We recorded the received power by the RX antenna vs. frequency at 200 relative orientations of the scattering surface (A stepper motor was used to rotate the scattering surface with 1.8° step size). At each orientation, the power was measured over a wideband frequency range (2 GHz-18 GHz).

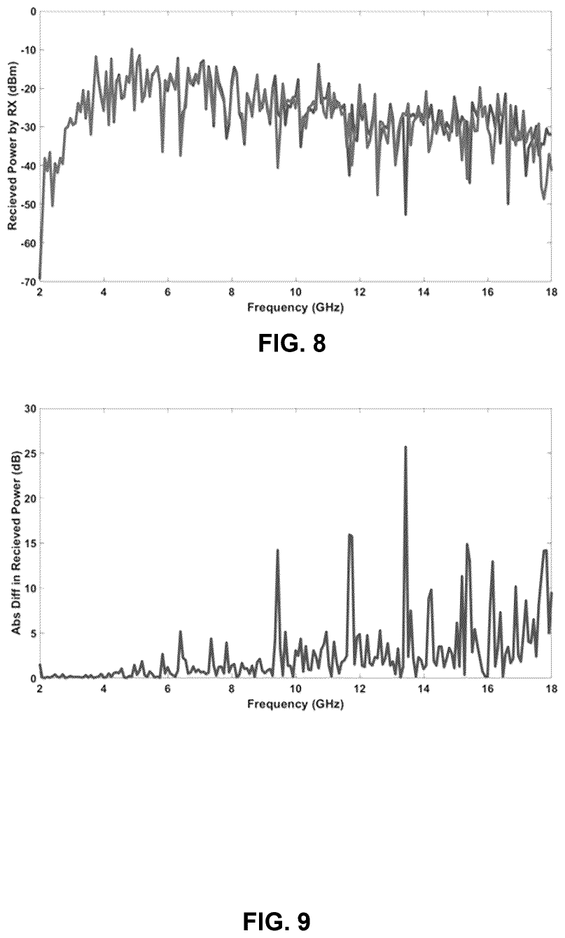

FIG. 8 illustrates received power by RX for two different scattering surface angles. The received power (in dBm) is a function of frequency for two different angle placements for the scattering surface. FIG. 9 illustrates the absolute difference between these two data curves. It is clearly seen that the difference gets more significant as the frequency increases.

Two metrics were used to obtain a qualitative measure of the field uniformity inside the freeze-dryer. The first metric is the maximum-to-minimum power ratio (MTMPR). MTMPR is obtained using the following

$$MTMPR = 10 {log}_{10} \frac{{P}_{max}}{{P}_{min}} \qquad ( Eq . 1 )$$

This metric considers a single location for the RX inside the dryer and evaluates the changes in the received power due to rotating the scattering surface. If the MTMPR is higher than 20 dB, it is said that the field is well stirred.

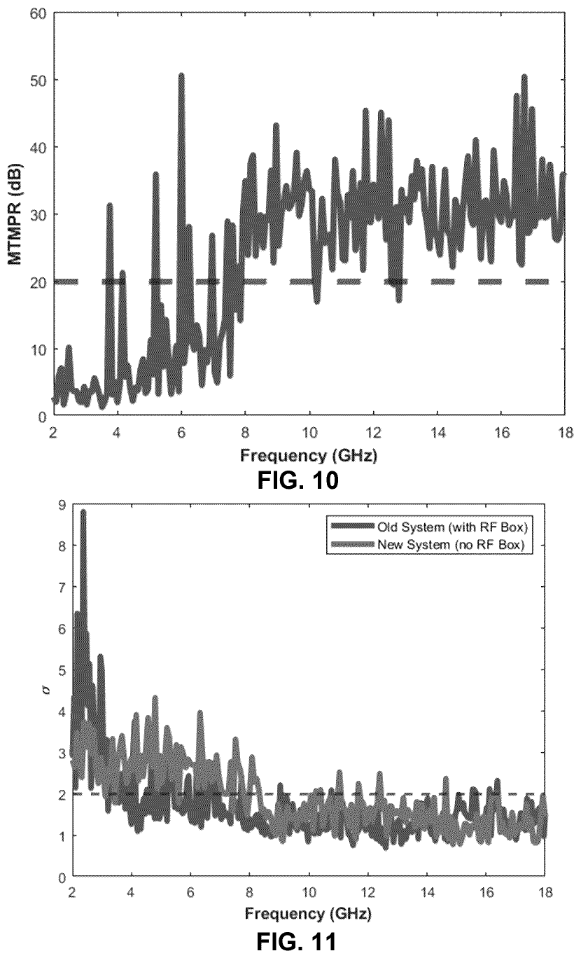

FIG. 10 below summarizes the obtained maximum-to-minimum power ratio (MTMPR) measurements as a function of frequency. It is seen that the MTMPR is higher than 20 dB over the frequency range of interest (8 GHz-18 GHz). This verifies that the implemented scattering surface effectively stirs the electromagnetic field inside the chamber. We observed an average of 30.2 dB over the frequency of interest.

The second metric measures the nonuniformity of the system. The power distribution is assumed to be uniform across the chamber within a prespecified standard deviation. If the standard deviation is lower than 3 dB, the field is said to be uniform. The embodiments described herein resulted in a standard deviation that was lower than 2 dB for most of the range (average standard deviation of 1.4 dB over the frequency of interest).

FIG. 11 compares the standard deviation of the old and new systems as a function of frequency. The standard deviation is obtained using the following:

$${σ}_{dB} = 10 {log}_{10} ( \frac{μ + {σ}_{linear}}{μ} ) \qquad ( Eq . 2 )$$

Where μ is the average received power, and σₗᵢₙₑₐᵣ represents the standard deviation of the data. It is seen that no significant difference can be observed over the specified frequency range (i.e., 8 GHZ-18 GHz). It is clearly seen that the old system is more effective for lower frequencies, which is attributed to the design of the scattering surface operating over the 8 GHz-18 GHz range. At lower frequencies, the scattering surface is not very effective. Hence, no well-stirred field is obtained.

Based on the obtained results, it is clearly seen that the system and methods described herein can provide a well-stirred environment without using an RF box. Hence, the new system offers a technical advancement at least because it addresses all the drawbacks associated with using an RF box and/or mechanical stirrer.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A freeze dryer system comprising:
a product chamber;
a reflective scattering surface disposed in the product chamber; and
an RF source connected to an antenna directed at the scattering surface, wherein the RF source is configured to emit electromagnetic waves via the antenna and the scattering surface is configured to reflect the electromagnetic waves in various directions.

2. The freeze dryer system of claim 1, wherein the scattering surface is positioned inside a product chamber and rotatable by a motor.

3. The freeze dryer system of claim 2, further comprising a door which provides access to an interior of the product chamber, wherein the motor is coupled to the door.

4. The freeze dryer system of claim 3, wherein the antenna is disposed in the product chamber on an interior side of the product chamber opposite the door.

5. The freeze dryer system of claim 3, wherein the scattering surface is connected to the motor via a shaft which extends through the door.

6. The freeze dryer system of claim 1, further comprising a condensation chamber connected to the product chamber, the condensation chamber comprising a condenser.

7. The freeze dryer system of claim 1, wherein the RF source is configured to cause the antenna to emit electromagnetic waves having a frequency in a range of 8 GHz-18 GHz.

8. The freeze dryer system of claim 1, further comprising:
a temperature-controlled shelf disposed in the product chamber.

9. The freeze dryer system of claim 1, wherein the scattering surface comprises: metallic patterns formed on a dielectric layer.

10. The freeze dryer system of claim 1, wherein the scattering surface is static and attached to a wall of the product chamber or a door of the product chamber.

11. The freeze dryer system of claim 10, wherein the RF source frequency modulates emission of the electromagnetic waves.

12. The freeze dryer system of claim 1, wherein a metallic mesh is used to prevent RF energy leakage out of the product chamber.

13. A method, comprising:
loading a product onto temperature-controlled shelves in a product chamber;
lowering a temperature of the temperature controlled shelves to freeze the product;
lowering a pressure of the product chamber to induce sublimation of a frozen solvent of the product; and
heating the product by radiating energy from an antenna toward a scattering surface disposed in the product chamber, wherein energy reflected from the scattering surface is directed toward the product; and
regulating pressure in the product chamber with a ballast gas.

14. The method of claim 13, wherein after regulating the pressure in the product chamber, the method further comprises:
removing the ballast gas from the product chamber with a vacuum pump causing sublimed vaper from the product to exit the product chamber and condense on a condenser; and
raising a temperature of the product.

15. The method of claim 14, wherein raising the temperature of the product comprises:
increasing the temperature of the temperature-controlled shelf.

16. The method of claim 14, wherein raising the temperature of the product comprises:
heating the product by radiating energy from the antenna toward the scattering surface.

17. The method of claim 13, further comprising rotating the scattering surface with a motor.

18. The method of claim 13, further comprising modulating the RF power and frequency of the electromagnetic waves emitted from the antenna.

19. The method of claim 13, wherein lowering the temperature of the temperature controlled shelves comprises lowering the temperature of the temperature controlled shelves until the product reaches a target temperature whereby the frozen solvent is separated from a solute.

20. The method of claim 13, wherein heating the product by radiating energy from an antenna toward the scattering surface comprises:
emitting, with an RF source, electromagnetic waves from the antenna having a frequency in a range of 8 GHz-18 GHz.
